(19) United States
(12) Patent Application Publication
(10) Pub. No.: US 2016/0061594 A1
(43) Pub. Date: Mar. 3, 2016

(54) SYSTEM AND METHOD OF MEASURING AND CORRECTING TILT ANGLE OF LENS

(71) Applicant: Samsung Electro-Mechanics Co., Ltd., Suwon-Si (KR)

(72) Inventors: Hyun KIM, Suwon-Si (KR); Bogdanov ILYA, Suwon-Si (KR); Kyung Hun LEE, Suwon-Si (KR)

(73) Assignee: SAMSUNG ELECTRO-MECHANICS CO., LTD., Suwon-Si (KR)

(21) Appl. No.: 14/641,082

(22) Filed: Mar. 6, 2015

(30) Foreign Application Priority Data
Sep. 2, 2014 (KR) 10-2014-0116480

(51) Int. Cl. G01B 11/26; G02B 7/36; G02B 7/28; H04N 5/262; H04N 5/225

(52) U.S. Cl. CPC G01B 11/26; H04N 5/2628; H04N 5/2254; G02B 7/282; G02B 7/36

(57) ABSTRACT

A system and a method of measuring and correcting an angle of tilt of a lens are provided. A resolution of the lens is measured using a test chart, and it is selected whether or not a tilt of the lens is corrected depending on whether or not the measured resolution of the lens is equal to or greater than a preset value. Whereby, productivity of a camera module may be improved.

### CROSS-REFERENCE TO RELATED APPLICATION

This application claims the priority and benefit of Korean Patent Application No. 10-2014-0116480 filed on Sep. 2, 2014, with the Korean Intellectual Property Office, the disclosure of which is incorporated herein by reference.

### BACKGROUND

The present disclosure relates to a system and a method of measuring and correcting an angle of tilt of a lens.

Recently, a digital camera function has been included in the majority of mobile communications terminals. In accordance with the improvement of the digital camera function included in the mobile communications terminals, camera modules including high-pixel image sensors have commonly been used.

Such camera modules have an auto-focusing (AF) function for auto-focusing a subject in which an actuator, such as a voice coil motor (VCM), or the like, is controlled to perform the auto-focusing function.

In such an auto-focusing operation, a lens may be moved from a macro focus position to an infinity focus position, within a movable range of the lens, and determine sharpness of an imaging target in each lens position to position the lens at a point at which sharpness is best.

Generally, in camera modules included in mobile communications terminals, an initial position of the lens is set by manually performing focusing and then fixing the lens in order to decrease current consumption at the time of conducting general photography or video photography.

Here, since a position of the fixed lens becomes an initial position for moving the lens at the time of performing auto-focusing, a driving distance of the lens, accuracy of the auto-focusing, and a resolution are determined.

Therefore, a method of finding an optical position of the lens and securing a driving distance of the lens for auto-focusing to increase accuracy of the auto-focusing has been required in the camera module.

Meanwhile, in the case in which an optical axis of the lens is not disposed to be perpendicular to an imaging surface of an image sensor, but is inclined at a specific angle with respect to the imaging surface due to various factors generated in a process of assembling the camera module, it has a negative impact on a resolution of the lens.

Therefore, a process of disposing the optical axis of the lens so as to be perpendicular to the imaging surface of the image sensor in the process of assembling the camera module is required.

### SUMMARY

An aspect of the present disclosure may provide a system and a method of measuring and correcting an angle of tilt of a lens, in which accuracy in measurement of a resolution of the lens and accuracy in measurement of an angle of tilt of the lens may be improved.

An aspect of the present disclosure may also provide a system and a method of measuring and correcting an angle of tilt of a lens, in which productivity of a camera module may be improved.

According to an aspect of the present disclosure, in a system and a method of measuring and correcting an angle of tilt of a lens, a resolution of the lens is measured using a test chart, and it is selected whether or not a tilt of the lens is corrected depending on whether or not the resolution of the lens is equal to or greater than a preset value, whereby productivity of a camera module may be improved.

In the system and the method of measuring and correcting an angle of tilt of a lens, a test chart in which a plurality of circular detection marks are disposed at predetermined intervals is used, whereby accuracy in measurement of the resolution of the lens may be improved.

In the system and the method of measuring and correcting an angle of tilt of a lens, the accuracy in the measurement of the resolution of the lens is improved, whereby accuracy in measurement of an angle of tilt and a degree of tilt of the lens may be improved.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a system of measuring and correcting an angle of tilt of a lens according to an exemplary embodiment of the present disclosure;

FIG. 2 is a plan view of a test chart used in the system of measuring and correcting an angle of tilt of a lens according to an exemplary embodiment of the present disclosure;

FIGS. 3A through 3C are conceptual diagrams showing the case in which a detection mark provided in the test chart has a rectangular shape;

FIG. 4 is a conceptual diagram showing a form in which the detection mark provided in the test chart used in the system of measuring and correcting an angle of tilt of a lens according to an exemplary embodiment of the present disclosure is projected on an image sensor;

FIG. 5 is a view showing a state in which the image sensor is rotated in FIG. 4;

FIG. 6 is a graph showing that peak values of spatial frequency responses appear so as to be different from each other depending on regions of a captured image in the captured image;

FIG. 7 is a graph showing that peak values of spatial frequency responses appear so as to be similar to each other in the captured image;

FIG. 8 is a perspective view showing a state in which a camera module is assembled;

FIG. 9 is a conceptual diagram showing a form in which a lens provided in the camera module is tilted with respect to an image sensor;

FIG. 10 is a conceptual diagram showing tilt regions divided on a virtual plane perpendicular to an optical axis of the lens;

FIG. 11 is a table showing a method of correcting a tilt of the lens in the system of measuring and correcting an angle of tilt of a lens according to an exemplary embodiment of the present disclosure; and

FIG. 12 is a flow chart showing a method of measuring and correcting an angle of tilt of a lens according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Terms with respect to directions will be first defined. An optical axis direction refers to a vertical direction based on a lens 10.

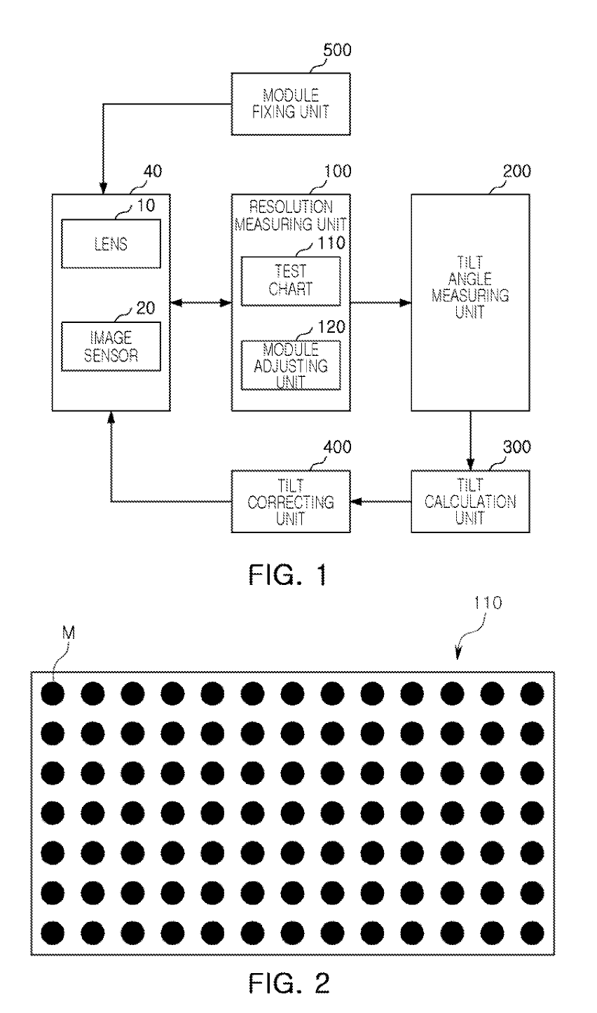

FIG. 1 is a block diagram of a system of measuring and correcting an angle of tilt of a lens according to an exemplary embodiment of the present disclosure.

Referring to FIG. 1, the system of measuring and correcting an angle of tilt of a lens according to an exemplary embodiment of the present disclosure may include a resolution measuring unit 100 measuring a resolution of a lens 10, a tilt angle measuring unit 200, a tilt calculating unit 300, a tilt correcting unit 400, and a module fixing unit 500.

The resolution measuring unit 100 may include a test chart 110 for measurement of the resolution and a module adjusting unit 120 changing a distance between the lens 10 and an image sensor 20.

The resolution measuring unit 100 may measure spatial frequency responses (SFRs) of the lens 10 using the test chart 110 to measure the resolution of the lens 10.

Here, in order to measure the resolution depending on the distance between the lens 10 and the image sensor 20, the module adjusting unit 120 may move the lens 10 in a range of infinity to macro, and the resolution measuring unit 100 may measure a resolution of the lens 10 in each position of the lens using the test chart 110.

The tilt angle measuring unit 200 may measure an angle of tilt between a virtual plane perpendicular to an optical axis of the lens 10 and the image sensor 20 from the measured spatial frequency responses (SFRs).

The virtual plane may mean a plane of a housing in which the lens 10 is accommodated, as described below.

The tilt calculation unit 300 may calculate a degree of tilt from the tilt angle measured by the tilt angle measuring unit 200.

The tilt correcting unit 400 may correct a degree of tilt between the virtual plane perpendicular to the optical axis of the lens 10 and the image sensor 20 depending on the degree of tilt calculated by the tilt calculation unit 300.

The module fixing unit 500 may fix a distance between the lens 10 and the image sensor 20 in a state in which the degree of tilt is corrected.

However, in the case in which the resolution of the lens 10 measured by the resolution measuring unit 100 is equal to a preset value or above, the distance between the lens 10 and the image sensor 20 may be fixed without performing a process of correcting the degree of tilt.

That is, in the system of measuring and correcting an angle of tilt of a lens according to an exemplary embodiment of the present disclosure, it may be determined from the resolution of the lens 10 measured by the resolution measuring unit 100 whether or not the tilt angle of the lens 10 is corrected.

Here, a position of the fixed lens 10 may become an initial position for moving the lens 10 at the time of performing auto-focusing.

Since the resolution of the lens 10 is measured to determine whether or not the tilt angle of the lens 10 is corrected, the tilt angle is not always corrected for each of manufactured camera modules, but may be selectively corrected, such that productivity of the camera module may be improved.

Next, a test chart used in the system of measuring and correcting an angle of tilt of a lens according to an exemplary embodiment of the present disclosure will be described with reference to FIGS. 2 through 5.

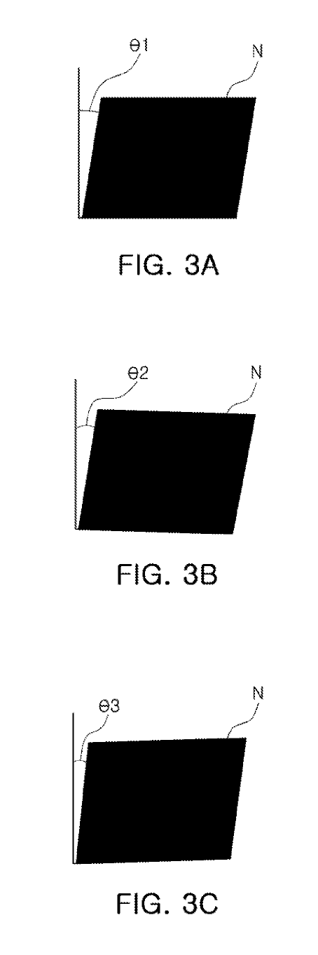

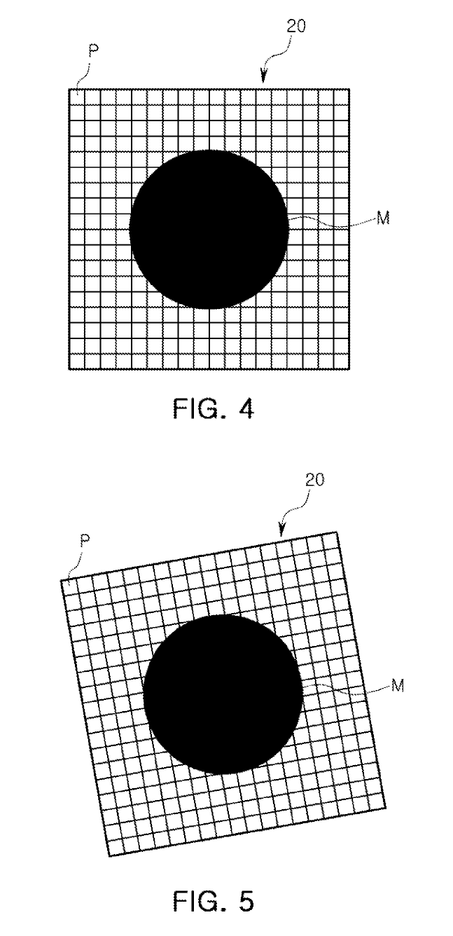

FIG. 2 is a plan view of a test chart used in the system of measuring and correcting an angle of tilt of a lens according to an exemplary embodiment of the present disclosure; FIGS. 3A through 3C are conceptual diagrams showing the case in which a detection mark provided in the test chart has a rectangular shape; FIG. 4 is a conceptual diagram showing a form in which the detection mark provided in the test chart used in the system of measuring and correcting an angle of tilt of a lens according to an exemplary embodiment of the present disclosure is projected on an image sensor; and FIG. 5 is a view showing a state in which the image sensor is rotated in FIG. 4

The resolution measuring unit 100 may measure the spatial frequency responses (SFRs) of the lens 10 using the test chart 110 to measure the resolution of the lens 10.

In the case in which an image of the test chart 110 formed on the image sensor 20 has brightnesses that are generally similar to each other (in the case in which a contrast of the image is low), a state in which a spatial correlation in a screen is high, the SFR may have a high value, and in the case in which the image of the test chart 110 formed on the image sensor 20 has different brightnesses (a contrast of the image is high), the SFR may have a high value.

As described above, the resolution measuring unit 100 may image the test chart 110 while changing the distance between the lens 10 and the image sensor 20, thereby evaluating the SFRs for each image.

In positions in which the lens is appropriately focused, different brightnesses included in the test chart 110 may be clearly distinguished from each other, such that a large SFR may appear, and in positions in which the lens is not appropriate focused, different brightnesses included in the test chart 110 may not be clearly distinguished from each other, such that a low SFR may appear.

Therefore, the resolution measuring unit 110 may measure the resolution of the lens 10 depending on the distance between the lens 10 and the image sensor 20, thereby finding an appropriate distance between the lens 10 and the image sensor 20.

Here, in order to improve accuracy of the SFRs of the lens 10, the test chart 110 may be provided with circular detection marks M.

For example, the test chart 110 may have a rectangular shape, and a color of a surface within an edge of the rectangular shape may be white.

In addition, the circular detection marks M having a black color may be provided in the test chart 110. However, the present disclosure is not limited thereto. That is, colors of the surface within the edge of the rectangular shape and the detection marks M may also be reversed to each other.

A plurality of circular detection marks M may be provided and be disposed within the edge of the rectangular shape of the test chart 110 so as to be spaced apart from each other by predetermined intervals.

Meanwhile, as shown in FIGS. 3A through 3C, in the case in which a detection mark N has a shape (for example, a rectangular shape) other than a circular shape, the detection mark N having the rectangular shape may have a predetermined inclined angle θ1 in order to allow a boundary line between a black color and a white color within the test chart to traverse a plurality of pixels.

Here, the resolution measuring unit 100 may measure the SFRs on the assumption of a preset inclined angle θ1 of the detection mark N. A process of aligning a camera module 40 including the lens 10 and the image sensor 20 and the test chart 110 with each other may be performed in order to deduce a predetermined result whenever the SFRs are measured.

However, in the case in which the camera module 40 and the test chart 110 are not aligned with each other, an inclined angle θ2 or θ3 of the imaged detection mark N may be different from the preset inclined angle θ1 (See FIGS. 3B and 3C). Therefore, the SFR value may include an error.

However, as described above, in the present exemplary embodiment, the detection marks M have the circular shape, whereby the imaged detection marks M may be maintained in the circular shape even through the process of aligning the camera module 40 and the test chart 110 with each other is not performed.

For example, even though the test chart 110 is imaged in a state in which the camera module 40 including the image sensor 20 is rotated as shown in FIG. 5, the detection marks M, which are targets to be imaged, have the circular shape, whereby shapes of the imaged detection marks M may not be changed (Compare FIGS. 4 and 5 with each other).

Therefore, since the shapes of the detection marks M, which are the targets to be imaged, are not changed even in a state in which the camera module 40 is rotated with respect to the test chart 110 at the time of measuring the resolution of the lens 10, a measurement error of the SFR may be decreased, and accuracy of the measured SFR may be improved.

In addition, the accuracy of the measured SFR may be improved to improve accuracy in measurement of the tilt angle and the degree of tilt of the lens 10.

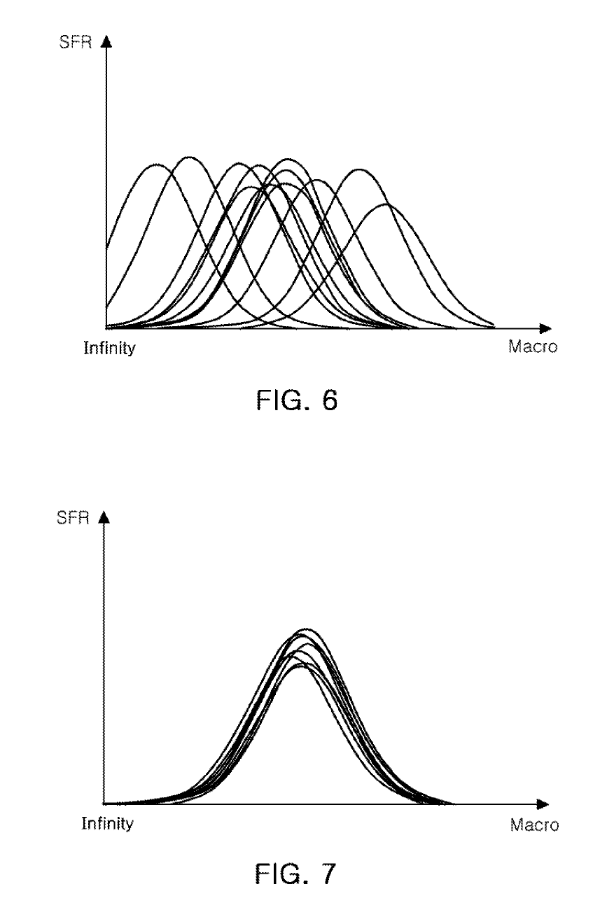

Next, the tilt angle measuring unit will be described with reference to FIGS. 6 and 7.

The resolution measuring unit 110 may evaluate SFRs for a peripheral region as well as to a central region on the imaged test chart 110.

In an ideal case in which the optical axis of the lens 10 is disposed so as to be perpendicular to an imaging surface of the image sensor 20, a peak value of the SFR in the central region of the captured image and a peak value of the SFR in the peripheral region of the captured image may appear in the same position of the lens (See FIG. 7).

This may mean that a position in which the lens 10 is appropriately focused based on the central region of the captured image and a position in which the lens 10 is appropriately focused based on the peripheral region of the captured image are the same as each other, which corresponds to an ideal case in which the optical axis of the lens 10 is disposed so as to be perpendicular to the imaging surface of the image sensor 20.

However, the optical axis of the lens 10 is not disposed so as to be perpendicular to the imaging surface of the image sensor 20, but may be inclined with respect to the imaging surface of the image sensor by a predetermined angle due to various factors generated in a process of assembling the camera module 40.

In this case, the peak value of the SFR in the central region of the captured image and the peak value of the SFR in the peripheral region of the captured image may appear in different positions of the lens (See FIG. 6).

This may mean that the position in which the lens 10 is appropriately focused based on the central region and the position in which the lens 10 is appropriately focused based on the peripheral region are different from each other.

This case may have a negative influence of the resolution. For example, image quality of the peripheral region of the captured image may be deteriorated.

Therefore, the position of the lens 10 may be adjusted so that peak values of the SFRs appear similarly to each other in all of the regions of the captured image.

Here, the tilt angle measuring unit 200 may measure the tilt angle of the lens 10 in order to adjust the position of the lens 10.

That is, the tilt angle measuring unit 200 may measure the tilt angle between the virtual plane perpendicular to the optical axis of the lens 10 and the image sensor 20 based on the position of the lens in which the peak value of the SFR measured by the resolution measuring unit 100 appears.

Here, the virtual plane may mean the plane of the housing in which the lens 10 is accommodated.

For example, the tilt angle measuring unit 200 may measure an angle of tilt of the lens in a horizontal direction, from the lowest position and the highest position of the lens in the horizontal direction of the imaged test chart 110 among positions of the lens in which the measured SFRs have the peak values.

The tilt angle measuring unit 200 may measure the tilt angle of the lens in the horizontal direction through a height difference of the lens calculated by comparing the lowest position and the highest position of the lens in the horizontal direction with each other and through a horizontal length of the virtual plane.

In addition, the tilt angle measuring unit 200 may measure an angle of tilt of the lens in a vertical direction, from the lowest position and the highest position of the lens in the vertical direction of the imaged test chart 110, among the positions of the lens in which the measured SFRs have the peak values.

The tilt angle measuring unit 200 may measure the tilt angle in the vertical direction through a height difference of the lens calculated by comparing the lowest position and the highest position of the lens in the vertical direction with each other and through a vertical length of the virtual plane.

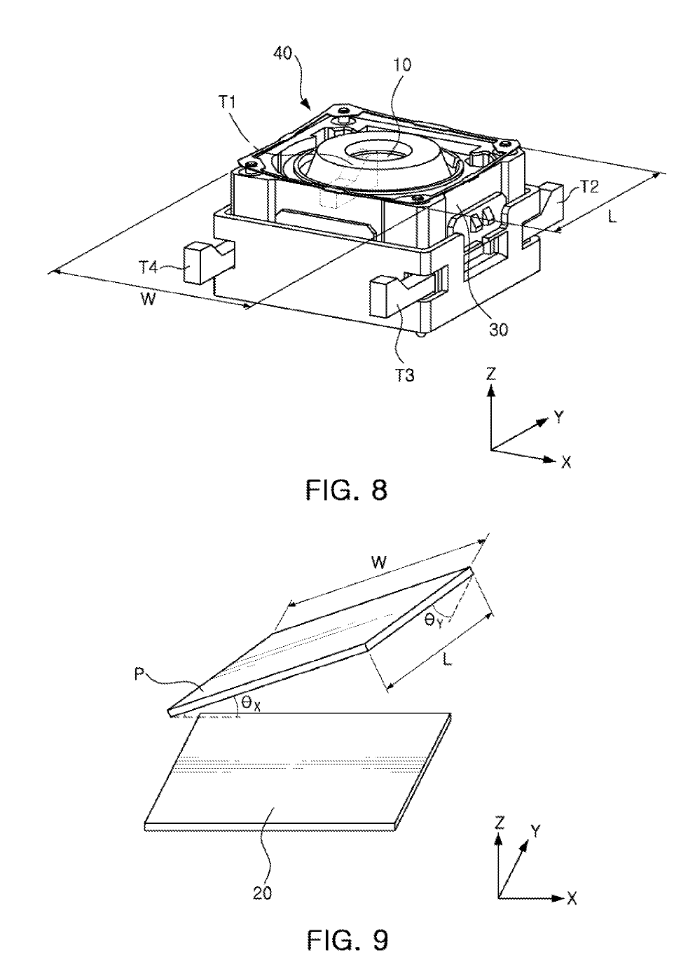

Next, a process of calculating the degree of tilt from the measured tilt angle and a process of correcting the tilt of the lens from the calculated tilt degree will be described with reference to FIGS. 8 through 11.

FIG. 8 is a perspective view showing a state in which a camera module is assembled; and FIG. 9 is a conceptual diagram showing a form in which a lens provided in the camera module is tilted with respect to an image sensor.

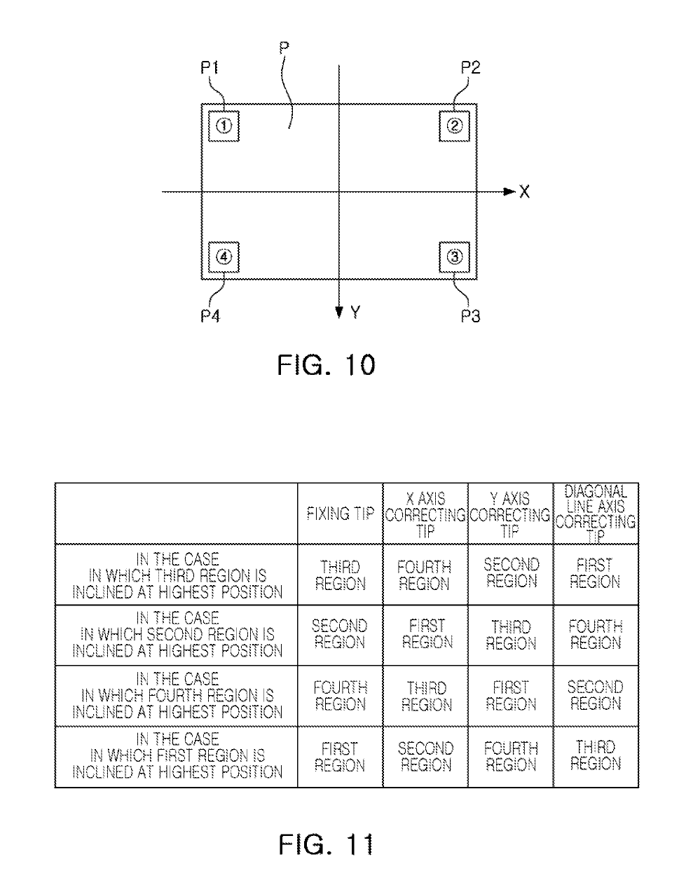

FIG. 10 is a conceptual diagram showing tilt regions divided on a virtual plane perpendicular to an optical axis of the lens; and FIG. 11 is a table showing a method of correcting a tilt of the lens in the system of measuring and correcting an angle of tilt of a lens according to an exemplary embodiment of the present disclosure.

First, referring to FIGS. 8 and 9, the case in which the virtual plane P perpendicular to the optical axis of the lens 10 and the image sensor 20 are not disposed in parallel with each other is shown.

That is, the optical axis of the lens 10 is not disposed so as to be perpendicular to the imaging surface of the image sensor 20, but is inclined with respect to the imaging surface by a predetermined angle.

The virtual plane P may mean the plane of the housing 30 in which the lens 10 is accommodated.

Since the lens 10 is in a state in which it is accommodated in the housing 30, in the case in which the optical axis of the lens 10 is not disposed so as to be perpendicular to the image sensor 20, the plane of the housing 30 may be in a state in which it is inclined with respect to the image sensor 20 by a predetermined angle.

Therefore, the measurement of the tilt angle and the correction of the tilt of the lens 10 may be performed through the plane of the housing 30, which is the virtual plane 30 perpendicular to the optical axis of the lens 10.

Here, four regions in the virtual plane P perpendicular to the optical axis of the lens 10 will be defined with reference to FIG. 10.

An X axis and a Y axis may be defined based on the center of the virtual plane P perpendicular to the optical axis of the lens 10, and the virtual plane P may be divided into a first region P1, a second region P2, a third region P3, and a fourth region P4 from the X and Y axes.

In addition, an angle of tilt in the case in which each region is inclined in a positive direction of a Z axis (here, the Z axis means a direction perpendicular to both of the X and Y axes) may be defined as a positive (+) tilt angle, and an angle of tilt in the case in which each region is inclined in a negative direction of the Z axis may be defined as a negative (−) tilt angle.

A state in which the virtual plane P is inclined with respect to the imaging surface of the image sensor 20 may be divided into a total of eight states.

For example, the state in which the virtual plane P is inclined with respect to the imaging surface of the image sensor 20 may be divided into a state in which the first region P1 is inclined in the positive direction of the Z axis as compared with the other regions, a state in which the second region P2 is inclined in the positive direction of the Z axis as compared with the other regions, a state in which the third region P3 is inclined in the positive direction of the Z axis as compared with the other regions, a state in which the fourth region P4 is inclined in the positive direction of the Z axis as compared with the other regions, a state in which the first region P1 and the second region P2 are inclined in the positive direction of the Z axis as compared with the other regions, a state in which the third region P3 and the fourth region P4 are inclined in the positive direction of the Z axis as compared with the other regions, a state in which the first region P1 and the fourth region P4 are inclined in the positive direction of the Z axis as compared with the other regions, and a state in which the second region P2 and the third region P3 are inclined in the positive direction of the Z axis as compared with the other regions.

In the present exemplary embodiment, as shown in FIGS. 8 and 9, the state in which the third region P3 is inclined in the positive direction of the Z axis as compared with the other regions will be described.

Referring to FIGS. 8 and 9, the third region P3 may be inclined so that both of the X and Y axes have a positive (+) tilt angle. That is, the X axis may be inclined in the positive direction of the Z axis by an angle of θ_{X}, and the Y axis may be inclined in the positive direction of the Z axis by an angle of θ_{Y}.

In this case, the first region P1, the second region P2, and the fourth region P4 may be moved in the positive direction of the Z axis in a state in which the third region P3 is fixed, thereby allowing the virtual plane P to be disposed in parallel with the imaging surface of the image sensor 20.

To this end, the tilt calculation unit 300 may calculate the degree of tilt from the measured tilt angle.

For example, when a horizontal length of the virtual plane P is W and a vertical length thereof is L, the tilt calculation unit 300 may calculate a degree of tilt of the lens in the horizontal direction, a degree of tilt of the lens in the vertical direction, and a degree of tilt of the lens in a diagonal line direction, from the measured tilt angles θ_{X} and θ_{Y}, W, and L.

The degree of tilt (C_{X}) in the horizontal direction may be calculated by W*tan(θ_{X}), the degree of tilt (C_{Y}) in the vertical direction may be calculated by L*tan(θ_{Y}), and the degree of tilt (C_{D}) in the diagonal line direction may be calculated by W*tan(θ_{X})+L*tan(θ_{Y}).

Next, a process of disposing the virtual plane P and the imaging surface of the image sensor 20 in parallel with each other through the calculated tilt degrees will be described.

As shown in FIG. 8, the tilt correcting unit 400 may include four adjusting tips T1 to T4 that may move or fix each region of the virtual plane P.

For example, the first adjusting tip T1 may move or fix the first region P1, and the second adjusting tip T2 may move or fix the second region P2.

In addition, the third adjusting tip T3 may move or fix the third region P3, and the fourth adjusting tip T4 may move or fix the fourth region P4.

In the case in which the third region P3 is inclined in the positive direction of the Z axis a compared with the other regions as in the case of FIGS. 8 and 9 described above, the first adjusting tip T1, the second adjusting tip T2, and the fourth adjusting tip T4 may be moved in a state in which the third region P3 is fixed using the third adjusting tip T3, thereby correcting the tilt.

For example, as shown in FIG. 11, the third adjusting tip T3 may serve as a fixing tip, the fourth adjusting tip T4 may serve as an X axis correcting tip, the second adjusting tip T2 may serve as a Y axis correcting tip, and the first adjusting tip T1 may serve as a diagonal line adjusting tip.

However, the present disclosure is not limited thereto. That is, only the second adjusting tip T2 and the fourth adjusting tip T4 may be moved without moving the first adjusting tip T1, which is the diagonal line adjusting tip, and only the first adjusting tip T1 may be moved without moving the second adjusting tip T2 and the fourth adjusting tip T4.

For example, when the fourth adjusting tip T4 is moved by an X axis tilt degree (W*tan (θ_{X})) on the virtual plane P as shown in FIG. 9 and the second adjusting tip T2 is moved by a Y axis tilt degree (L*tan (θ_{Y})) on the virtual plane P as shown in FIG. 9, a degree of tilt in the first region P1 may be naturally corrected without moving the first adjusting tip T1.

In addition, when the first adjusting tip T1 is moved by the X axis tilt degree (W*tan (θ_{X})) and the Y axis tilt degree (L*tan(θ_{Y})), degrees of tilt in the second region P2 and the fourth region P4 may be naturally corrected without moving the second adjusting tip T2 and the fourth adjusting tip T4.

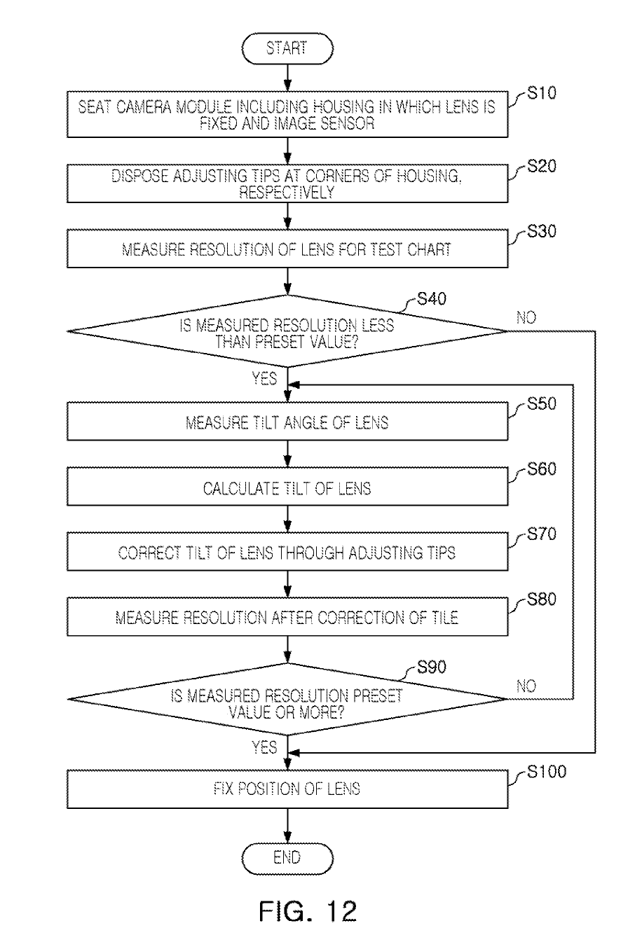

FIG. 12 is a flow chart showing a method of measuring and correcting an angle of tilt of a lens according to an exemplary embodiment of the present disclosure.

The method of measuring and correcting an angle of tilt of a lens according to an exemplary embodiment of the present disclosure will be described with reference to FIG. 12.

First, the camera module 40 including the housing 30 in which the lens 10 is accommodated and the image sensor 20 may be seated in the system of measuring and correcting an angle of tilt of a lens according to an exemplary embodiment of the present disclosure (S10).

When the camera module 40 is seated, the adjusting tips T1 to T4 may be disposed at corners of the housing 30, respectively.

When the displacement of the plurality of adjusting tips T1 to T4 is completed, the test chart 110 may be captured, and the resolution of the lens 10 may be measured using an image of the test chart 110 (S30).

However, the present disclosure is not limited thereto. For example, the resolution of the lens 10 may be measured by imaging the test chart 110, simultaneously with disposing the adjusting tips T1 to T4 at the corners of the housing 30, respectively.

The resolution of the lens 10 may be measured by measuring the SFRs using the image of the test chart 110.

When the resolution of the lens 10 is measured, the measured resolution and a preset value may be compared with each other (S40).

In the case in which the measured resolution is the preset value or more, the distance between the lens 10 and the image sensor 20 may be fixed without correcting the tilt angle of the lens 10.

Here, the position of the fixed lens 10 may become the initial position for moving the lens 10 at the time of performing auto-focusing.

In the case in which the measured resolution is less than the preset value, the distance between the lens 10 and the image sensor 20 may be fixed after a process of correcting the tilt angle of the lens 10 is performed.

Then, the tilt angle of the lens 10 may be measured using the measured resolution (S50).

The measurement of the tilt angle θ_{X} of the lens 10 in the horizontal direction may be performed by comparing the lowest position and the highest position of the lens in the horizontal direction of the imaged test chart 110 with each other, among the positions of the lens in which the measured SFRs have the peak values.

In addition, the measurement of the tilt angle θ_{Y} of the lens 10 in the vertical direction may be performed by comparing the lowest position and the highest position of the lens in the vertical direction of the imaged test chart 110 with each other, among the positions of the lens in which the measured SFRs have the peak values.

Next, the degree of tilt of the lens 10 may be calculated from the measured tilt angle (S60).

The degree of tilt of the lens 10 may be calculated based on the virtual plane P perpendicular to the optical axis of the lens 10.

For example, when the horizontal length of the virtual plane P is W and the vertical length thereof is L, the degree of tilt of the lens in the horizontal direction, the degree of tilt of the lens in the vertical direction, and the degree of tilt of the lens in the diagonal line direction may be calculated from the measured tilt angles θ_{X} and θ_{Y}, W, and L.

The degree of tilt (C_{X}) in the horizontal direction may be calculated by W*tan(θ_{X}), the degree of tilt (C_{Y}) in the vertical direction may be calculated by L*tan(θ_{Y}), and the degree of tilt (C_{D}) in the diagonal line direction may be calculated by W*tan(θ_{X})+L*tan(θ_{Y}).

Next, the tilt of the lens 10 may be corrected depending on the calculated tilt degree (S70).

Here, since the lens 10 is accommodated in the housing 30, even though the lens 10 is not directly moved, an effect of moving the lens 10 may be obtained by moving the housing 30.

For example, when the housing 30 is moved through the plurality of adjusting tips T1 to T4, since the lens 10 accommodated in the housing 30 is also moved, the tilt of the lens 10 may be corrected by moving the housing 30.

Next, after the tilt of the lens 10 is corrected, the test chart 110 may be again imaged to measure a resolution of the lens 10 (S80).

The resolution of the lens 10 measured after the tilt of the lens 10 is corrected may be again compared with a preset value (S90).

When the resolution of the lens 10 measured after the tilt of the lens 10 is corrected is less than the preset value, the tilt of the lens may be again corrected.

When the resolution of the lens 10 measured after the tilt of the lens 10 is corrected is the preset value or more, the distance between the lens 10 and the image sensor 20 may be fixed (S100).

As set forth above, with the system and the method of measuring and correcting an angle of tilt of a lens according to exemplary embodiments of the present disclosure, the accuracy in the measurement of the resolution of the lens and the accuracy in the measurement of the tilt angle of the lens may be improved.

In addition, productivity of the camera module may be improved.

While exemplary embodiments have been shown and described above, it will be apparent to those skilled in the art that modifications and variations could be made without departing from the scope of the present invention as defined by the appended claims.

What is claimed is:

1. A system of measuring and correcting an angle of tilt of a lens, comprising:
a resolution measuring unit measuring a resolution of the lens using a test chart, depending on a distance between the lens and an image sensor;
a tilt angle measuring unit measuring an angle of tilt between a virtual plane perpendicular to an optical axis of the lens and the image sensor using the measured resolution;
a tilt calculating unit calculating a degree of tilt of the lens from the measured tilt angle; and
a tilt correcting unit correcting a degree of tilt of the lens depending on the calculated degree of tilt.

2. The system of measuring and correcting an angle of tilt of a lens of claim 1, wherein the resolution measuring unit includes the test chart.

3. The system of measuring and correcting an angle of tilt of a lens of claim 2, wherein the test chart has a plurality of detection marks which have a circular shape.

4. The system of measuring and correcting an angle of tilt of a lens of claim 3, wherein the plurality of detection marks are disposed at predetermined intervals.

5. The system of measuring and correcting an angle of tilt of a lens of claim 3, wherein a surface of the test chart and the plurality of detection marks have different colors.

6. The system of measuring and correcting an angle of tilt of a lens of claim 3, wherein a color of a surface of the test chart is white and a color of the plurality of detection marks is black.

7. The system of measuring and correcting an angle of tilt of a lens of claim 1, wherein the resolution measuring unit measures spatial frequency responses with respect to an image obtained by imaging the test chart.

8. The system of measuring and correcting an angle of tilt of a lens of claim 7, wherein the resolution measuring unit measures spatial frequency responses with respect to a central region and a peripheral region of the image.

9. The system of measuring and correcting an angle of tilt of a lens of claim 7, wherein the tilt angle measuring unit measures an angle of tilt of the lens in a horizontal direction, from a lowest position of the lens and a highest position of the lens in the horizontal direction of the image among positions of the lens in which the measured spatial frequency responses have peak values.

10. The system of measuring and correcting an angle of tilt of a lens of claim 9, wherein the tilt calculation unit calculates the degree of tilt of the lens as follows:
C_{X}=W*tan(θ_{X})
where C_{X} is a degree of tilt of the lens in the horizontal direction, W is a horizontal length of a housing in which the lens is fixed, and θ_{X} is an angle of tilt of the lens in the horizontal direction.

11. The system of measuring and correcting an angle of tilt of a lens of claim 7, wherein the tilt angle measuring unit measures an angle of tilt of the lens in a vertical direction, from a lowest position and a highest position of the lens in the vertical direction of the imaged test chart among positions of the lens in which the measured spatial frequency responses have peak values.

12. The system of measuring and correcting an angle of tilt of a lens of claim 11, wherein the tilt calculation unit calculates the degree of tilt of the lens as follows:
C_{Y}=L*tan(θ_{Y})
where C_{Y} is a degree of tilt of the lens in the vertical direction, L is a vertical length of a housing in which the lens is fixed, and θ_{Y} is an angle of tilt of the lens in the vertical direction.

13. The system of measuring and correcting an angle of tilt of a lens of claim 7, wherein the tilt angle measuring unit measures an angle of tilt of the lens in a horizontal direction, from a lowest position and a highest position of the lens in the horizontal direction of the image among positions of the lens in which the measured spatial frequency responses have peak values, and
measures an angle of tilt of the lens in a vertical direction, from a lowest position and a highest position of the lens in the vertical direction of the image among positions of the lens in which the measured spatial frequency responses have peak values.

14. The system of measuring and correcting an angle of tilt of a lens of claim 13, wherein the tilt calculation unit calculates the degree of tilt of the lens as follows:
C_{D}=W*tan(θ_{X})+L*tan(θ_{Y})
where C_{D} is a degree of tilt of the lens in a diagonal line direction, W is a horizontal length of a housing in which the lens is fixed, L is a vertical length of the housing, ex is an angle of tilt of the lens in the horizontal direction, and θ_{Y} is an angle of tilt of the lens in the vertical direction.

15. The system of measuring and correcting an angle of tilt of a lens of claim 1, wherein the tilt correcting unit includes a plurality of adjusting tips moving or fixing the respective corners of a housing in which the lens is fixed.

16. The system of measuring and correcting an angle of tilt of a lens of claim 15, wherein the tilt correcting unit fixes a position of a corner of the housing positioned at a highest position in an optical axis direction among the respective corners of the housing and moves the other corners depending on the calculated degree of tilt of the lens, through the plurality of adjusting tips.

17. The system of measuring and correcting an angle of tilt of a lens of claim 1, further comprising a module adjusting unit fixing a position of the lens when the resolution of the lens measured by the resolution measuring unit is equal to or greater than a preset value.

18. A method of measuring and correcting an angle of tilt of a lens, comprising:
measuring a resolution of the lens using a test chart including circular detection marks, depending on a distance between the lens and an image sensor;
fixing a position of the lens when the measured resolution is equal to or greater than a preset value and measuring an angle of tilt of the lens when the measured resolution is less than the preset value;
calculating a degree of tilt of the lens using the measured tilt angle of the lens; and
correcting a degree of tilt of the lens depending on the calculated degree of tilt of the lens.

19. The method of measuring and correcting an angle of tilt of a lens of claim 18, further comprising, before the measuring of the resolution of the lens, moving a plurality of adjusting tips correcting the degree of tilt of the lens to positions adjacent to a housing.

20. The method of measuring and correcting an angle of tilt of a lens of claim 18, further comprising, during the measuring of the resolution of the lens, moving a plurality of adjusting tips correcting the degree of tilt of the lens to positions adjacent to a housing.

21. The method of measuring and correcting an angle of tilt of a lens of claim 18, wherein the measuring of the resolution of the lens is performed by measuring spatial frequency responses with respect to an image of the test chart.

22. The method of measuring and correcting an angle of tilt of a lens of claim 21, wherein in the measuring of the tilt angle of the lens, an angle of tilt of the lens in a horizontal direction is measured from a lowest position and a highest position of the lens in the horizontal direction of the image among positions of the lens in which the measured spatial frequency responses have peak values.

23. The method of measuring and correcting an angle of tilt of a lens of claim 22, wherein in the calculating of the degree of tilt of the lens, a degree of tilt of the lens in the horizontal direction is calculated by W*tan(θ_{X}),
where W is a horizontal length of a housing in which the lens is fixed, and θ_{X} is an angle of tilt of the lens in the horizontal direction.

24. The method of measuring and correcting an angle of tilt of a lens of claim 21, wherein in the measuring of the tilt angle of the lens, an angle of tilt of the lens in a vertical direction is measured from a lowest position and a highest position of the lens in the vertical direction of the image among positions of the lens in which the measured spatial frequency responses have peak values.

25. The method of measuring and correcting an angle of tilt of a lens of claim 24, wherein in the calculating of the degree of tilt of the lens, a degree of tilt of the lens in the vertical direction is calculated by L*tan(θ_{Y}),
where L is a vertical length of a housing in which the lens is accommodated, and θ_{Y} is an angle of tilt of the lens in the vertical direction.

26. The method of measuring and correcting an angle of tilt of a lens of claim 21, wherein in the measuring of the tilt angle of the lens, an angle of tilt of the lens in a horizontal direction is measured from a lowest position and a highest position of the lens in the horizontal direction of the image among positions of the lens in which the measured spatial frequency responses have peak values, and
an angle of tilt of the lens in a vertical direction is measured from a lowest position and a highest position of the lens in the vertical direction of the image among positions of the lens in which the measured spatial frequency responses have peak values.

27. The method of measuring and correcting an angle of tilt of a lens of claim 26, wherein in the calculating of the degree of tilt of the lens, a degree of tilt of the lens in a diagonal line direction is calculated by W*tan (θ_{X})+L*tan(θ_{Y}),
where W is a horizontal length of a housing in which the lens is fixed, L is a vertical length of the housing, θ_{X} is an angle of tilt of the lens in the horizontal direction, and θ_{Y} is an angle of tilt of the lens in the vertical direction.

28. The method of measuring and correcting an angle of tilt of a lens of claim 18, wherein in the correcting of the degree of tilt of the lens, a position of a corner of the corner positioned at a highest position in an optical axis direction among the respective corners of the housing in which the lens is fixed, and the other corners are moved depending on the calculated degree of tilt of the lens, through the plurality of adjusting tips.
